(19) United States
(12) Patent Application Publication
(10) Pub. No.: US 2016/0149276 A1
(43) Pub. Date: May 26, 2016

(54) BATTERY MODULE FOR AN ELECTRIC OR HYBRID VEHICLE INCORPORATING A HEAT EXCHANGER

(71) Applicant: VALEO SYSTEMES THERMIQUES, Le Mesnil Saint Denis cedex (FR)

(72) Inventors: Gilles ELLIOT, Courcouronnes (FR); Vincent FEUILLARD, Le Mesnil Saint Denis (FR)

(73) Assignee: VALEO SYSTEMES THERMIQUES, Le Mesnil Saint Denis cedex (FR)

(21) Appl. No.: 14/900,713

(22) PCT Filed: Jun. 23, 2014
(86) PCT No.: PCT/EP2014/063190

§ 371 Date: Dec. 22, 2015

(30) Foreign Application Priority Data
Jun. 26, 2013 (FR) 1356114

(51) Int. Cl. H01M 10/656; H01M 10/0525

(52) U.S. Cl. CPC H01M 10/656; H01M 10/0525; H01M 2220/20

(57) ABSTRACT

The invention relates mainly to a battery module for an electric or hybrid vehicle, comprising a stack of flexible electrochemical cells, essentially characterised in that it comprises a heat exchanger including a fluid inlet and a fluid outlet between which a device for guiding the flow of a fluid provides at least two heat exchange portions, with two electrochemical cells being inserted between said heat exchange portions and in bearing contact therewith. The invention also relates to a battery for an electric or hybrid vehicle comprising an assembly of battery modules

The invention relates primarily to a battery module for an electric or hybrid vehicle provided with a heat exchanger.

The invention relates also to a battery comprising an assembly of several battery modules.

The technical field of the invention relates to the energy sources with electrochemical storage comprising a plurality of electrochemical cells connected in series. These energy sources are applied notably to electric batteries to ensure the traction of electric or hybrid vehicles.

A battery comprises an assembly of modules, which themselves comprise an assembly of electrochemical cells.

In these cells, reversible electrochemical reactions take place that make it possible to produce current when the battery is discharging, or to store energy when the battery is charging. Batteries of lithium-ion type are particularly well known.

The electrochemical cells can be of cylindrical, prismatic or flexible type. In the technology of flexible cells, commonly called “pouch-cells”, each cell comprises a metal plate incorporating a positive electrode, a negative electrode and a separator. Each cell also comprises a positive terminal and a negative terminal which, in the case of “series” wiring, are each respectively linked to the negative terminal and to the positive terminal of the adjacent cells.

The chargings and dischargings of the battery provoke a heat production which can lead to premature corruption, even to deterioration of the cells.

The document U.S. Pat. No. 6,512,347 discloses a battery module which makes it possible to cool the electrochemical cells of which it is composed. This battery module comprises a heat exchanger, at least one flexible electrochemical battery cell, at least one thermally conductive plate in contact with the outer surface of the cells, and a coil which comprises a coolant. The coil is, on the one hand, linked at each of its ends to the heat exchanger, and is, on the other hand, in thermal contact with the conductive plates.

It has, however, been found that this battery module does not make it possible to obtain a satisfactory heat exchan particularly in the coil which is positioned on the top face of the battery module. Furthermore, the heat exchange is not ensured uniformly throughout the battery module.

The object of the present invention is to resolve this problem by proposing a battery module for an electric or hybrid vehicle which comprises a stacking of electrochemical cells and a heat exchanger whose structure and positioning relative to the surfaces of the cells makes it possible to improve the effectiveness of the heat exchangers.

To this end, the battery module of the invention is essentially characterized in that it comprises a heat exchanger comprising a fluid inlet and a fluid outlet and a device making it possible to guide the flow of a fluid, this guiding device being arranged between the fluid inlet and the fluid outlet, the device for guiding the flow of a fluid comprises at least two heat exchange portions between which is positioned at least one electrochemical cell at least partially in bearing contact against said heat exchange portions.

In this way, the battery module according to the invention advantageously makes it possible to pick up and discharge the calories from the electrochemical cells without the need to use two distinct parts each specifically assigned to the calorie pick-up function or to the calorie discharge function. Thus, the battery module according to the invention notably makes it possible to dispense with the use of a calorie-draining thermally conductive plate in contact with the outer surface of the cells.

Furthermore, the direct contact between the heat exchange portions of said guiding device makes it possible to ensure an optimized cooling of the electrochemical cells, the fluid contained in the heat exchange portions being as close as possible to the source of heat.

The battery module of the invention can also comprise the following optional features, considered in isolation or in all technically p1ossible combinations:
the device making it possible to guide the flow of a fluid comprises a first duct part which winds from the fluid inlet to the last cell and a second part, connected to said first part, which winds in the battery module from the last cell of the module1 to the fluid outlet;
a joining duct extending against a face of the last cell ensures the join between the first part and the second part;
the device making it possible to guide the flow of a fluid winds in the battery module from the fluid inlet to the fluid outlet by forming a succession of hairpins each comprising:
   two substantially parallel heat exchange portions between which is positioned at least one electrochemical cell at least partially in bearing contact against said heat exchange portions, and
   a joining portion in the form of a circular arc linking the two heat exchange portions, this portion preferentially extending beyond the faces of the cells concerned, located substantially facing said joining portion;
      in this way, the heat exchange surface between said heat exchange portions and the electrochemical cells is optimal, thus favoring the picking up and the discharging of the calories;
the device making it possible to guide the flow of a fluid is at least one fluid circulation duct that can be at least one flat tube, preferentially curved;
the device making it possible to guide the flow of a fluid comprises at least two channels adapted for the flow of said fluid;
the heat exchange portions have a substantially parallelepipedal form;
according to a first variant, the fluid inlet is arranged at the level of the heat exchange portion in contact with the first cell of the module, the fluid outlet is arranged at the level of the heat exchange portion in contact with the last cell of the module, and the device making it possible to guide the flow of a fluid winds over the entire length of the module from the fluid inlet to the fluid outlet;
according to a second variant, the fluid inlet and the fluid outlet are arranged at the level of the heat exchange portion in contact with the first cell of the module, the device making it possible to guide the flow of a fluid comprises a first part which winds from the fluid inlet to the last cell by forming a succession of hairpins each comprising two substantially parallel heat exchange portions between which is arranged at least one electrochemical cell in bearing contact against said heat exchange portions and which are linked together by a joining portion in the form of a circular arc preferentially extending beyond the faces of the cells concerned located substantially facing the joining portion, and the device making it possible to guide the flow of a fluid comprises a second part, connected to said first part, which winds in the battery module from the last cell of the module to the fluid outlet by forming a succession of hairpins each comprising two substantially parallel heat exchange portions between which is arranged at least one electrochemical cell in bearing contact against said heat exchange portions and which are linked together by a joining portion in the form of a circular arc preferentially extending beyond the faces of the cells concerned located substantially facing the joining portion;
in this second variant, the electrochemical cells in bearing contact with two heat exchange portions of the first part of the device making it possible to guide the flow of a fluid are also in bearing contact with two heat exchange portions of the second part of said guiding device;
   in this way, the fluid passes through the battery module in one direction, from the fluid inlet to the fluid outlet, then in the other direction, from the fluid outlet to the fluid inlet, which advantageously makes it possible to make the temperature uniform between the first cell and the last cell; furthermore, the positioning of the fluid inlet and the fluid outlet in proximity to one another makes it possible to simplify the connection thereof to a fluid circuit;
in this second variant, the first and the second parts of the device making it possible to guide the flow of a fluid are arranged in such a way that one of the lateral edges of the first part is facing one of the lateral edges of the second part;
preferentially, in this second variant, the electrical interconnection of the cells of the first and second parts is performed respectively at the lateral edge opposite that located facing the lateral edge of the other part;
the heat exchanger of the battery module comprises at least one plate made of elastic material arranged between the electrochemical cells positioned between two heat exchange portions; each plate made of elastic material is attached the face of a cell opposite the face in contact with the heat exchange portion;
according to an execution variant, the plate made of elastic material is a foam plastic plate;
according to an execution variant, the plate made of elastic material is produced in a plastic material such as an electrical insulator that can be EPDM (ethylene-propylene-diene-monomer);
in this way, each plate made of elastic material makes it possible to ensure the pressing of the electrochemical cells against the heat exchange portions of the exchanger and compensate for the expansions;
the fluid circulating in the heat exchanger is preferentially a refrigerant, which advantageously makes it possible to discharge significant quantities of calories, thus making it possible to expose the electrochemical cells to conditions that involve a high temperature rise, such as a rapid charging of the battery module;
the fluid circulating in the heat exchanger is a refrigerant or a heating fluid; the heat exchanger of the battery module according to the invention thus makes it possible to cool said module but also to heat it up by having a heating fluid circulate in the exchanger;
the positive and negative terminals of each electrochemical cell are linked together by electrical connectors situated on the free faces of the cells;
the battery module is of lithium-ion type.

The invention relates also to a battery for an electric or hybrid vehicle which is essentially characterized in that it comprises an assembly of battery modules as previously defined.

Other features and advantages of the invention will clearly emerge from the description given below, in an indicative and nonlimiting manner, with reference to the attached figures in which:

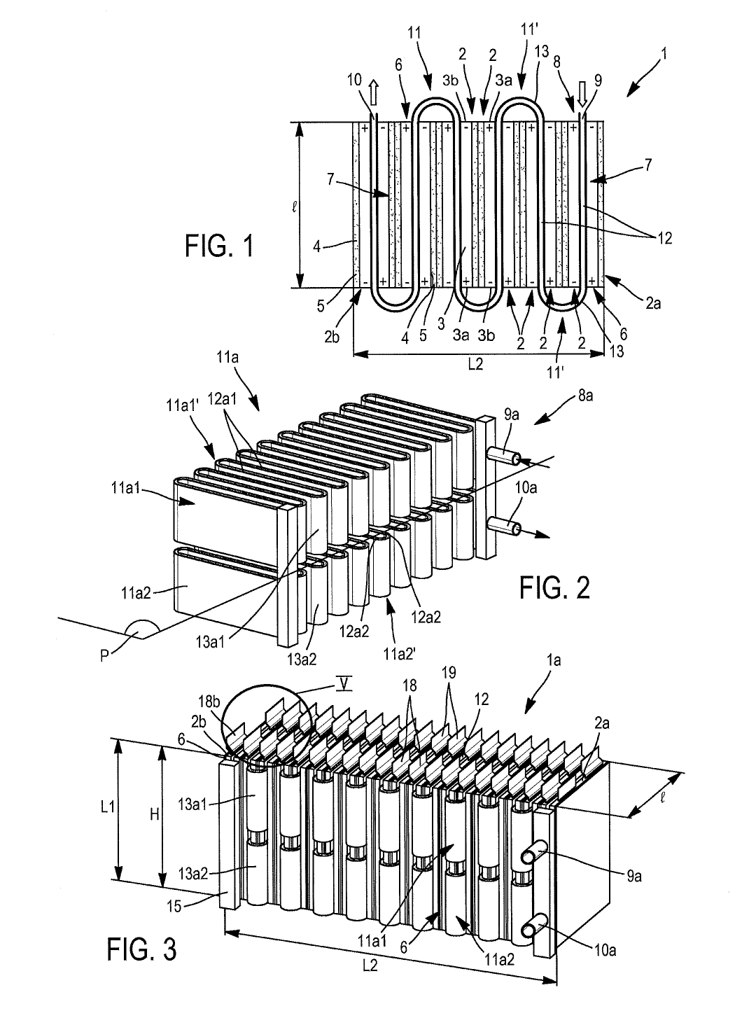

FIG. 1 is a partial cross-sectional schematic representation of a battery module of the invention according to a first variant,

FIG. 2 is a perspective schematic representation of the heat exchanger of the battery module of the invention according to a second variant,

FIG. 3 is a perspective schematic representation of the battery module of the invention according to the second variant,

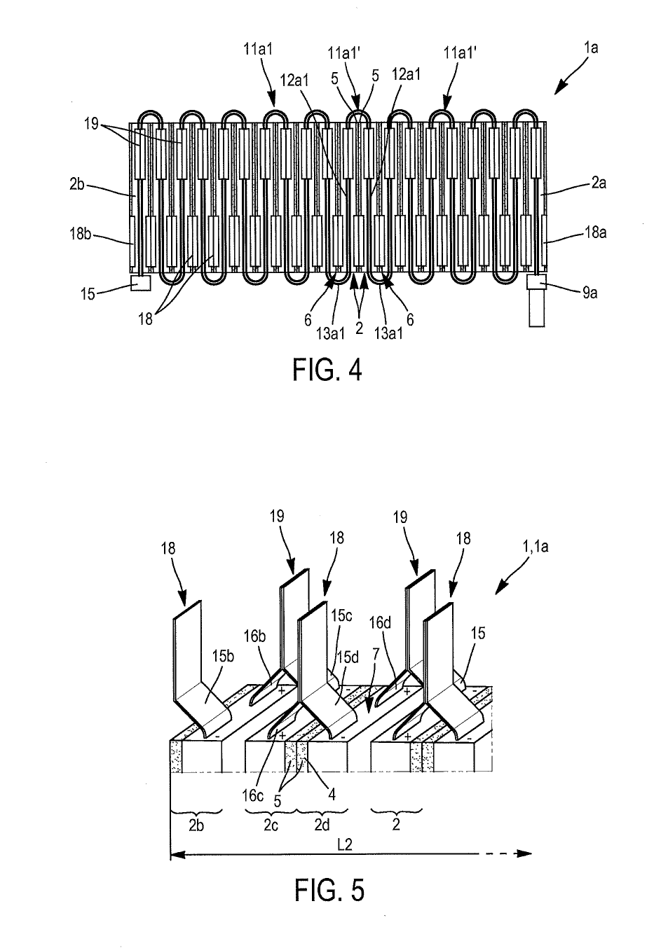

FIG. 4 is a plan view schematic representation of the battery module of the invention according to the second variant, and

FIG. 5 is an enlarged view of the circled part V of FIG. 3.

Referring to FIG. 1, the battery module of the invention 1 according to a first variant comprises a stacking of cells 2 each comprising a metal plate 3 which comprises a positive electrode 3a, a negative electrode 3b and a separator not represented. For each cell 2, a foam plastic plate 5 is attached to one of the faces 4 of the cell 2. The particular arrangement and the functionality of this foam plastic plate 5 will be explained later.

Moreover, each cell 2 comprises two opposing first faces 6 corresponding to the length L1 of each cell 2 (FIG. 3) and along which extend either the positive electrode 3a or the negative electrode 3b of the cell 2 concerned. Each cell 2 also has two opposing second faces 7 corresponding to the width 1 of each cell 2 and along which extend, on one side, the positive electrode 3a and, on the other side, the negative electrode 3b.

According to the invention, a heat exchanger 8 comprises a fluid inlet 9 and a fluid outlet 10 between which a device making it possible to guide the flow of a fluid 11, such as, for example, a fluid circulation duct, winds between the cells 2 of the module 1. The fluid is most often a refrigerant, but the invention applies also to the use of a heating fluid.

More specifically, the fluid circulation duct 11 comprises a flat tube and forms, by its serpentine configuration, a plurality of hairpins 11′ each formed notably by two substantially parallel heat exchange portions 12 between which are arranged two electrochemical cells 2 in bearing contact against said heat exchange portions 12.

As can be seen in FIG. 1, the foam plastic plate 5 is situated on the face 4 of each cell 2 which is opposite that located in contact with the heat exchange portion 12. Thus, each cell 2 is in contact with a heat exchange portion 12.

The foam plastic plates 5 make it possible to press the positive 3a and negative 3b terminals against the associated heat exchange portions 12. These foam plastic plates 5 thus make it possible to absorb the significant expansions of the cells 2 in contact with the heat exchanger 8 by providing an optimized contact surface between these cells 2 and the corresponding heat exchange portions 12.

Moreover, each heat exchange portion 12 extends over the entire width 1 of the cells 2, but also over a part of the length L1 of each cell 2, the latter configuration not being visible in FIG. 1.

The module of the invention 1 thus comprises, according to a particular embodiment, a succession of patterns each comprising a first heat exchange portion 12, a first cell 2, a first foam plastic plate 5, a second foam plastic plate 5, a second cell 2 and a second heat exchange portion 12, all these elements being in solid bearing contact against one another.

Moreover, for each hair pin 11′ of the fluid circulation duct 11, the two heat exchange portions 12 are linked together by a joining portion 13 in the form of a circular arc which extends beyond the first faces 6 of the cells concerned 2 facing said joining portion 13. It will be understood that, for two adjacent hairpins 11′ comprising a common heat exchange portion 12, one 13 of the joining portions will be situated at the level of a first face 6 of the cells 2 and the other joining portion 13 will be situated at the level of the opposite face 6 of the cells 2.

The joining portions 13 are produced by bending the flat tube of which the fluid circulation duct 11 is composed.

As illustrated in FIG. 1, the fluid inlet 9 is arranged at the first cell 2a of the module 1 and the fluid outlet 10 is arranged at the last cell 2b of the module 1. The fluid circulation duct 11 then winds over the entire length L2 of the module 1, this length L2 being, in the case in point, substantially equal to the sum of the thicknesses of the cells 2, the thicknesses of the foam plastic plates 5, and the thicknesses of the heat exchange portions 12.

Referring to FIGS. 2 to 4, and according to the second variant of the invention, the module of the invention 1a comprises a stacking of cells 2 which are configured and arranged in the same way as for the first variant. The references in common with the first variant are thus repeated.

According to this second variant, the heat exchanger 8a comprises a fluid inlet 9a and a fluid outlet 10a both situated at the level of the heat exchange portion 12 in contact with the first cell 2a of the module 1. The fluid circulation duct 11a comprises two parts, a first duct part 11a1 which winds between the fluid inlet 9a to the last cell 2b of the module 1 and a second part 11a2 which winds, in such a way that the faces of the cells 2 of the first part 11a1 are facing the faces of the cells 2 of the second part 11a2, from the last cell 2b to the fluid outlet 10a.

The join between the first 11a1 and the second 11a2 parts of the fluid circulation duct 11a is ensured by a joining duct 20 extending against a face 6 of the last cell 2b.

In a manner similar to the first variant, each first 11a1 and second 11a2 part of the fluid circulation duct 11a comprises a plurality of hairpins 11a1′ , 11a2′ each notably comprising two substantially parallel heat exchange portions 12a1, 12a2 (FIG. 2) between which are inserted two electrochemical cells 2 in bearing contact against said heat exchange portions 12a1, 12a2 (FIG. 4).

Also in a manner similar to the first variant, each heat exchange portion 12a1, 12a2 is linked to the adjacent heat exchange portion 12a1, 12a2 by a corresponding joining portion 13a1, 13a2 in the form of a circular arc which extends beyond the first faces 6 of the cells 2 concerned.

The first 11a1 and second 11a2 parts of the fluid circulation duct 11 exhibit a symmetry relative to a median longitudinal plane P of the module 1 (FIG. 2). Thus, the hairpins 11a1′ of the first duct part 11a1 are arranged in such a way that one of their lateral sides is facing one of the lateral sides of the hairpins 11a2′ of the second duct part 11a2. The result thereof is that two cells 2 in bearing contact with two heat exchange portions 12a1 of the first duct part 11a1 will also be in contact with two heat exchange portions 12a of the second duct part 11a2.

Thus, advantageously, according to this variant, the heat transfer exhibits an optimized uniformity between all the cells 2 of the module 1. Furthermore, the fluid inlet 9a and the fluid outlet 10a are situated in proximity to one another, at the same point of the module 1, which simplifies the fluid interconnections.

There now follows a description of the electrical connections applied to the module of the invention 1, 1a. This description is given with reference to FIGS. 3 to 5 illustrating the second variant of the invention, but applies also to the configuration of the first variant.

Referring to FIG. 5, two cells 2c, 2d are considered, inserted into two respective hairpins 11a1 11a2′ of the fluid circulation duct 11a that is not visible in this figure. These two cells 2c, 2d are separated by two foam plastic plates 5 attached against the respective faces 4 of each of these cells 2c, 2d.

According to a variant execution of the invention that is not represented, the two cells 2c, 2d are separated only by a single foam plastic plate 5.

According to another variant execution of the invention that is not represented, a single cell 2 and a foam plastic plate 5 are inserted into the space delimited by a hair pin 11′, the foam plastic plate 5 being attached to the cell 2.

The first cell 2c comprises a negative terminal 15c and a positive terminal 16c, and the second cell 2d also comprises a negative terminal 15d and a positive terminal 16d. The negative 15c and positive 16c terminals of the first cell 2c are situated on the free second face 7 of the cells and are arranged in opposition relative to the negative 15d and positive 16d terminals of the second cell 2d.

The positive terminal 16c of the first cell 2c is linked to the negative terminal 15d of the second cell 2d by a first collector 18 comprising positive 16c and negative 15d terminals which are secured at their top end. The negative terminal 15c of the first cell 2c is, for its part, linked to the positive terminal 16b of the adjacent cell 2b by a second collector 19 of the same configuration which is staggered relative to the first collector 18. Similarly, the positive terminal 16d of the second cell 2d is linked to the negative terminal 15 of its adjacent cell 2 by a second collector 19.

As can be seen in FIGS. 3 to 5, the first 18 and the second 19 collectors are arranged staggered on the free faces 7 of the cells 2 over the entire length L2 of the module of the invention 1, 1a.

As represented in FIG. 5, the negative terminal 15b of the last cell 2b of the module la forms the general negative terminal 15b of the module 1a, this negative terminal 15b being linked to a collector 18b. The same applies for the first cell 2a not represented, for which its associated positive terminal forms the general positive terminal of the module of the invention 1a, this positive terminal 15a being linked to a collector 18a.

The module of the invention thus provides a heat exchanger for which the circulation of the fluid takes place in the thickness of the module in direct contact with the electrochemical cells. This contact is promoted by the presence of plates of elastic material which absorb the expansion effects resulting from the surface contact between the cells and the fluid circulation duct. The result thereof is an optimized heat exchange in the module.

Finally, the module of the invention applies preferentially to cells of lithium-ion type but can also be applied to any other type of cell.

1. A battery module for an electric or hybrid vehicle comprising a stacking of flexible electrochemical cells, characterized in that it comprises a heat exchanger comprising a fluid inlet and a fluid outlet and a device making it possible to guide the flow of a fluid, this guiding device being arranged between the fluid inlet and the fluid outlet, the device for guiding the flow of a fluid comprises at least two heat exchange portions between which is positioned at least one electrochemical cell at least partially in bearing contact against said heat exchange portions.

2. The battery module as claimed in claim 1, characterized in that wherein the device making it possible to guide the flow of a fluid winds in the battery module from the fluid inlet to the fluid outlet by forming a succession of hairpins each comprising:
two substantially parallel heat exchange portions between which is positioned at least one electrochemical cell at least partially in bearing contact against said heat exchange portions, and
a joining portion in the form of a circular arc linking the two heat exchange portions, this portion extending beyond the faces of the cells concerned, located substantially facing the joining portion.

3. The battery module as claimed in claim 1, wherein the device making it possible to guide the flow of a fluid is a flat tube.

4. The battery module as claimed in claim 1, wherein the device making it possible to guide the flow of a fluid comprises at least two channels adapted for the flow of said fluid.

5. The battery module as claimed in claim 1, wherein the fluid inlet is arranged at the level of the heat exchange portion in contact with the first cell of the module, in that the fluid outlet is arranged at the level of the heat exchange portion in contact with the last cell of the module, and in that the device making it possible to guide the flow of a fluid winds over the entire length of the module from the fluid inlet to the fluid outlet.

6. The battery module as claimed in claim 1, wherein the fluid inlet and the fluid outlet are arranged at the level of the heat exchange portion in contact with the first cell of the module, in that the device making it possible to guide the flow of a fluid comprises a first duct part which winds from the fluid inlet to the last cell by forming a succession of hairpins each comprising two substantially parallel heat exchange portions between which is arranged at least one electrochemical cell in bearing contact against said heat exchange portions and which are linked together by a joining portion in the form of a circular arc extending beyond the faces of the cells concerned located substantially facing the joining portion, and in that the device making it possible to guide the flow of a fluid comprises a second part, connected to said first part, which winds in the battery module from the last cell of the module to the fluid outlet by forming a succession of hairpins each comprising two substantially parallel heat exchange portions between which is arranged at least one electrochemical cell in bearing contact against said heat exchange portions and which are linked together by a joining portion in the form of a circular arc extending beyond the faces of the cells concerned located substantially facing the joining portion.

7. The battery module as claimed in claim 6, wherein, the electrochemical cells in bearing contact with two heat exchange portions of the first part of the device making it possible to guide the flow of a fluid are also in bearing contact with two heat exchange portions of the second part of said device making it possible to guide the flow of a fluid.

8. The battery module as claimed in claim 1, wherein the heat exchanger of the battery module comprises at least one plate made of elastic material arranged between the electrochemical cells positioned between two heat exchange portions, each plate made of elastic material is attached to the face of a cell opposite the face in contact with the heat exchange portion.

9. The battery module as claimed in claim 8, wherein the plate made of elastic material is a foam plastic plate.

10. The battery module as claimed in claim 1, wherein the positive and negative terminals of each electrochemical cell are linked together by electrical connectors situated on the free faces of the cells.

11. The battery module as claimed in claim 1, wherein it is of lithium-ion type.

12. A battery for an electric or hybrid vehicle, characterized in that it comprises an assembly of battery modules as claimed in claim 1.
